(19) United States
(12) Patent Application Publication
(10) Pub. No.: US 2022/0218142 A1
(43) Pub. Date: Jul. 14, 2022

(54) PRESSURE-ADJUSTABLE PNEUMATIC SYSTEM OF SODA MACHINE

(71) Applicant: Jinye GUAN, Guangzhou (CN)

(72) Inventor: Jinye GUAN, Guangzhou (CN)

(21) Appl. No.: 17/595,206

(22) PCT Filed: May 12, 2020
(86) PCT No.: PCT/CN2020/089795

§ 371 Date: Nov. 11, 2021

(30) Foreign Application Priority Data
May 14, 2019 (CN) 201920694207.1

(51) Int. Cl. A47J 31/40; A47J 31/44; A47J 31/46

(52) U.S. Cl. CPC A47J 31/40; A47J 31/461; A47J 31/4403

(57) ABSTRACT

A pressure-adjustable pneumatic system of soda machine, comprising upper cover (1), air inlet support (2), air distribution valve (3), sub-machine support (5), safety valve (8), piston-type pressure driving device (9), and further comprising driving base (41), knob (42), driving gear (43), driving wheel set (44), driven wheel set (45), drive gear (46). The first (41) and the second gear (2) connected driving wheel set; first gear (441) matches with driving gear (43); rotating shaft (453) fitted with driven wheel, the upper end of the rotating shaft is fixedly connected to speed reducing wheel (451), the lower end of the rotating shaft is connected to shaft body (4521) of driven gear (452); drive gear (46) is fixedly connected to shaft head (9421), also (46) extends into circular counter bore (2A) through hole, the driven gear (452) is located in the circular counter bore (2A), engaged with the drive gear (46); handheld part (421) of the knob (42) extends out of the upper cover (1) through knob hole (1A). Rotate the knob (42), drive gear (46) push rod nut (94) to rotate, adjust spring's elasticity, the internal pressure of exhaust driving pipeline drives piston, it's convenient to make soda have different concentrations.

### CROSS-REFERENCE TO RELATED APPLICATION(S)

This application is a 371 International Patent Application No. PCT/CN2020/089795, filed on May 12, 2020, which claims the priority and benefit of Chinese patent application number 201920694207.1, filed May 14, 2019 with China National Intellectual Property Administration, the entire contents of which are incorporated herein by reference.

### TECHNICAL FIELD

The present utility model relates to a soda machine, in particular to a pneumatic system of a soda machine.

### BACKGROUND

At present, in the prior art, Chinese patent application 201920547808.X, filed on Apr. 19, 2019, is entitled as PNEUMATIC SYSTEM OF SODA MACHINE INTEGRATING AIR INLET, DRIVING, PRESSURE RELIEF AND EXHAUST. A pneumatic system of soda machine integrating air inlet, driving, pressure relief and exhaust comprises an upper cover 1, an air inlet support 2, an air distribution valve 3, a support base 4, a sub-machine support 5, an air inlet nozzle assembly 6, a truncated cone sleeve 7, a safety valve 8 and a piston-type pressure driving device 9. As shown in FIG. 1, FIG. 2 and FIG. 3, the exhaust driving pipeline 33 is provided with an interface 331, the piston-type pressure driving device 9 is fixed on the air inlet support 2, and the piston pressure driving device 9 is communicated with the interface 331. As shown in FIG. 1 and FIG. 3, the piston-type pressure driving device 9 comprises a cylinder 91 with an open end, an air inlet interface 911 provided at the air inlet end of the cylinder, a piston 92, a sealing rubber plug 921, an ejector rod 93 connected with the piston, a spring and a push rod nut 94, wherein the open end of the cylinder 91 is provided with internal threads; the push rod nut 94 comprises a body part 941, an operating part 942 surrounding the body part for rotating a tool, an upper guide hole 943 provided on the body part and a counter hole 944; the body part 941 comprises an external thread part and a sealing part; the air inlet interface 911 is inserted into the interface 331 of the exhaust driving pipeline 33, the sealing rubber plug 921 is provided at one end of the piston 92, the sealing rubber plug 921 is fitted with the closed air inlet of the cylinder 92, the spring is sleeved on the ejector rod 93, the external thread of the push rod nut 94 is screwed with the internal thread of the cylinder 91; the spring extends into the counter bore 944, and the ejector rod 93 extends through the guide hole 943. The ejector rod drives the locking mechanism of the air outlet valve of the main body. The existing problem is that when the elasticity of the spring in the piston-type pressure drive device is adjusted, the adjustment can only be carried out after disassembly, so that the pressure drive of the soda bottle of the sub-machine is adjusted.

### SUMMARY

The purpose of the present utility model is to provide a pressure-adjustable pneumatic system of a soda machine, which can conveniently adjust the elasticity of the spring, keep different pressures in the soda bottle, and manufacture soda with different concentrations.

The present utility model is realized as follows: a pressure-adjustable pneumatic system of a soda machine, comprising an upper cover, an air inlet support, an air distribution valve, a sub-machine support, a safety valve, and a piston-type pressure driving device, wherein the air distribution valve comprises an air inlet cavity, an air inlet interface communicated with the air inlet cavity, an exhaust cavity surrounding the air inlet cavity, an exhaust driving pipeline communicated with the exhaust cavity, and an exhaust valve provided on the exhaust driving pipeline, the exhaust driving pipeline is provided with an interface, the piston-type pressure driving device comprises a cylinder with an open end, an air inlet interface provided at the air inlet end of the cylinder, a piston, a sealing rubber plug, an ejector rod connected with the piston, a spring and a push rod nut, wherein the open end of the cylinder is provided with internal threads; the push rod nut comprises a body part, an operating part surrounding the body part, an upper guide hole provided on the body part and a counter hole; the body part comprises an external thread part and a sealing part; the sealing rubber plug is provided at one end of the piston, the sealing rubber plug is fitted with the closed air inlet of the cylinder, the spring is sleeved on the ejector rod, the external thread of the push rod nut is screwed with the internal thread of the cylinder; the spring extends into the counter bore, the ejector rod extends through the guide hole, the piston-type pressure driving device is fixed on the air inlet support, the air inlet interface is inserted into the interface; the sub-machine support is connected with the outer cover and the lower end of the air inlet support; wherein the upper cover is provided with a knob hole; the operating part is provided with a shaft head; the air inlet support is provided with a circular counter bore, the bottom plate of the circular counter bore is provided with a through hole, and the through hole is opposite to the shaft head;

the system further comprises a driving base, a knob, a driving gear, a driving wheel set, a driven wheel set, and a drive gear;

the driving base comprises a circular base cavity, a driving wheel set base and a driven wheel set base, wherein the circular base cavity is communicated with the driving wheel set base; the driving wheel set comprises a first gear, a second gear and a fixed shaft; the driven wheel set comprises a speed reducing wheel, a driven wheel and a rotating shaft, the driven wheel comprises a shaft body, a cylinder with an open lower part and teeth provided at the open end of the cylinder;

the driving base is fixed on the air inlet support, the lower shaft body of the driving gear is rotatably fitted with the bottom plate of the circular base cavity, the connecting rod at the upper end is connected with the connecting part of the knob; the first gear and the second gear are provided vertically and pivotedly connected to a driving wheel set base by means of a fixed shaft, the first gear is engaged with the driving gear; a rotating shaft is rotatably fitted with a driven wheel set base, the upper end of the rotating shaft is fixedly connected to a speed reducing wheel, and the lower end of the rotating shaft is connected to a shaft body of a driven gear;

the drive gear is fixedly connected to a shaft head, the drive gear extends into a circular counter bore through a through hole, and the driven gear is located in the circular counter bore and engaged with the drive gear; and a handheld part of the knob extends out of the upper cover through a knob hole.

According to the pressure-adjustable pneumatic system of a soda machine, the lower end of the shaft base of the first gear of the driving wheel set is provided with a sub-clutch sleeve, the upper end of the shaft base of the second gear is provided with a female clutch sleeve, and the upper end of the fixed shaft is provided with an external thread;

the upper base plate of the driving wheel set base is provided with a threaded hole, and the lower base plate is provided with a fixed hole;

the system further comprises a tension spring,

the upper end of the fixed shaft is screwed with the threaded hole and the lower end thereof is inserted with the fixed hole; the tension spring is sleeved on the fixed shaft; the upper end and the lower end of the tension spring are fitted with the shaft base and the lower base plate of the second gear, respectively; and the sub-clutch sleeve and the female clutch sleeve are engaged.

According to the pressure-adjustable pneumatic system of a soda machine, the driving base is provided with a gear cavity, and the gear cavity is communicated with the cylindrical base through a guide hole;

the system further comprises a sliding rod and a pressure spring, wherein the sliding rod is provided with a spring base plate;

the driven end of the sliding rod passes through a pressure spring, one end of the pressure spring is fitted with the end plate of the gear cavity and the other end thereof is fitted with the spring base plate, and the driving end of the sliding rod is fitted with the gear hole on the connecting part of the knob through the guide hole.

The present utility model relates to a pressure-adjustable pneumatic system of a soda machine. Since such a structure is used, the knob is rotated, the drive gear drives a push rod nut to rotate, and the elasticity of a spring is adjusted, so that the internal pressure of an exhaust driving pipeline drives a piston, the purpose of making soda having different concentrations is achieved, and adjustment is convenient.

### BRIEF DESCRIPTION OF THE DRAWINGS

FIG. 1 is a cross-sectional view of the prior art.

FIG. 2 is a view A-A of FIG. 1.

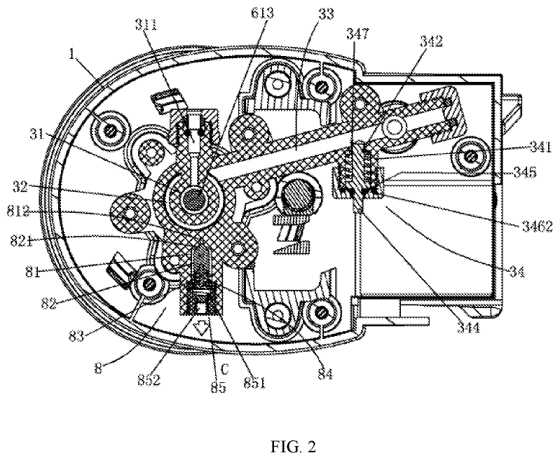

FIG. 3 is a view B-B of FIG. 1.

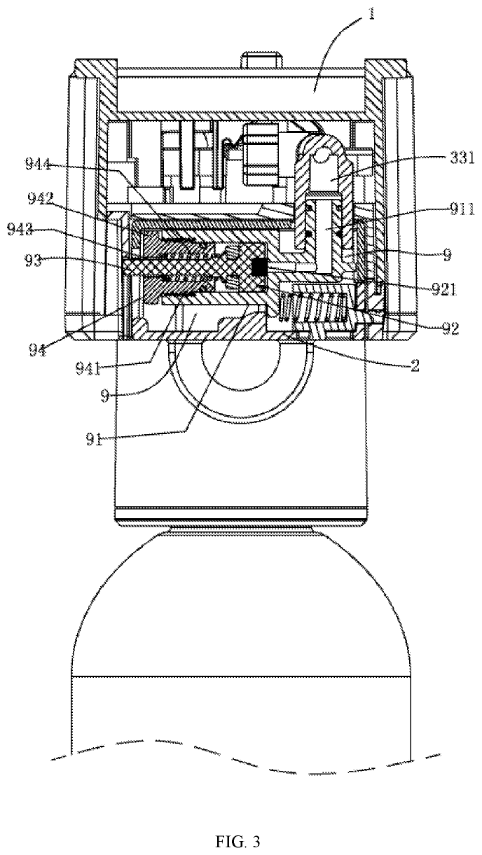

FIG. 4 is a perspective view of the present utility model.

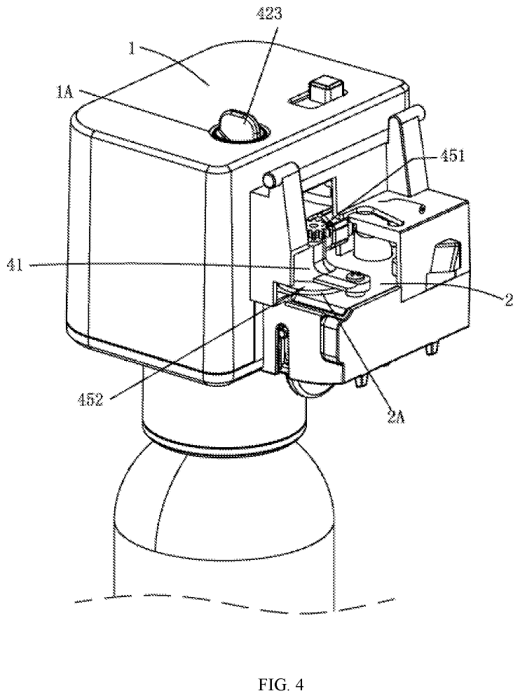

FIG. 5 is a cross-sectional view of the present utility model.

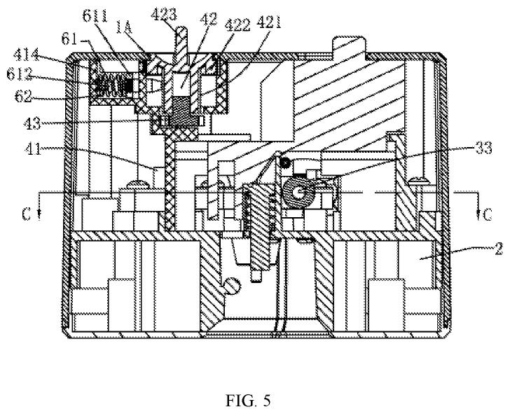

FIG. 6 is a view C-C of FIG. 5.

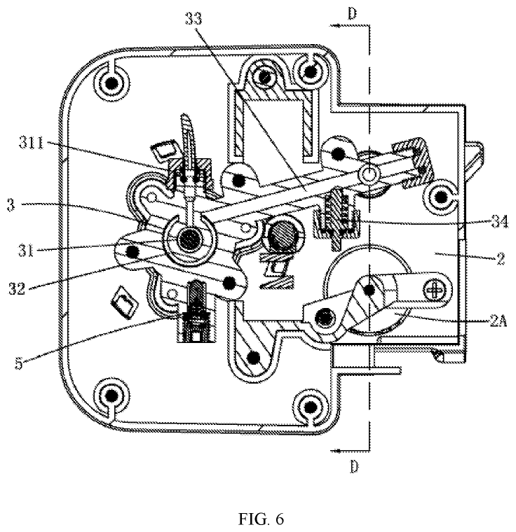

FIG. 7 is a view D-D of FIG. 6.

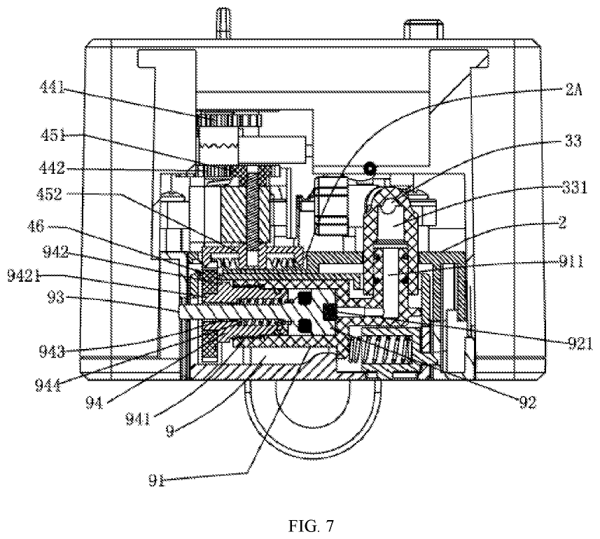

FIG. 8 is a top view of a driving mechanism according to the present utility model.

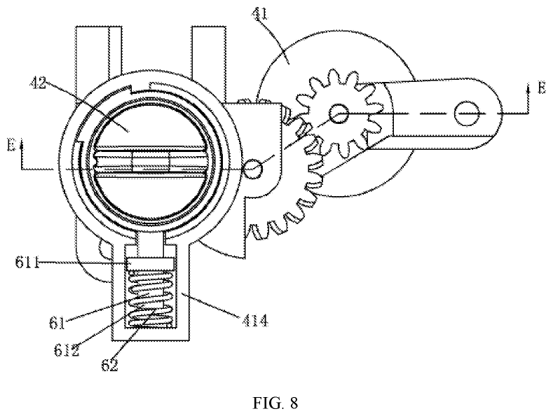

FIG. 9 is a view E-E of FIG. 8.

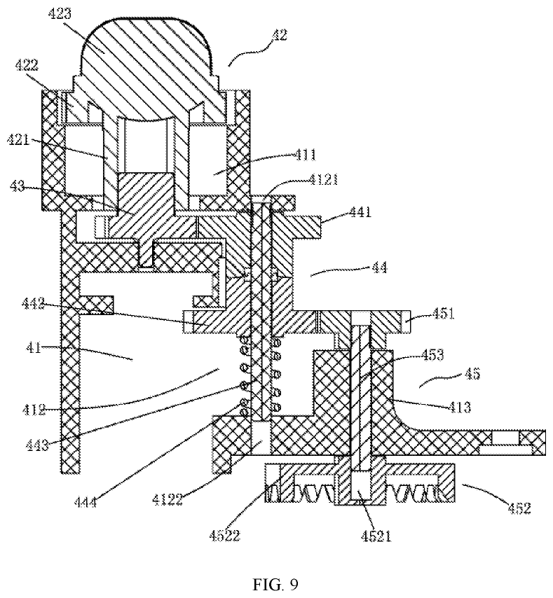

### DETAILED DESCRIPTION OF THE EMBODIMENTS

The present utility model will be further described with reference to the attached drawings.

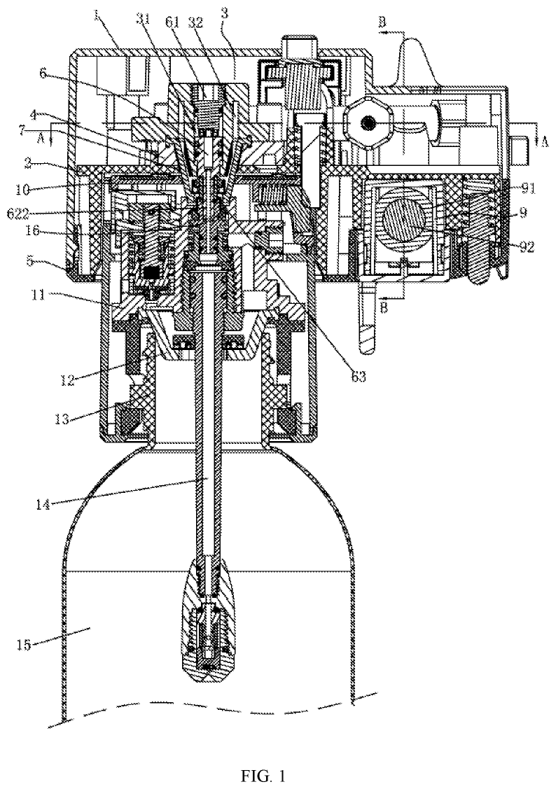

As shown in FIG. 1, a pressure-adjustable pneumatic system of a soda machine comprises an upper cover 1, an air inlet support 2, an air distribution valve 3, a sub-machine support 5, a safety valve 8, and a piston-type pressure driving device 9. The air distribution valve 3 comprises an air inlet cavity 31, an air inlet interface 311 communicated with the air inlet cavity, an exhaust cavity 32 surrounding the air inlet cavity, an exhaust driving pipeline 33 communicated with the exhaust cavity, and an exhaust valve 34 provided on the exhaust driving pipeline. The exhaust driving pipeline 33 is provided with an interface 331. The piston-type pressure driving device 9 comprises a cylinder 91 with an open end, an air inlet interface 911 provided at the air inlet end of the cylinder, a piston 92, a sealing rubber plug 921, an ejector rod 93 connected with the piston, a spring and a push rod nut 94. The open end of the cylinder 91 is provided with internal threads. The push rod nut 94 comprises a body part 941, an operating part 942 surrounding the body part, an upper guide hole 943 provided on the body part and a counter hole 944. The body part 941 comprises an external thread part and a sealing part. The sealing rubber plug 921 is provided at one end of the piston 92. The sealing rubber plug 921 is fitted with the closed air inlet of the cylinder 91. The spring is sleeved on the ejector rod 93. The external thread of the push rod nut 94 is screwed with the internal thread of the cylinder 91. The spring extends into the counter bore 944. The ejector rod 93 extends through the guide hole 943. The piston-type pressure driving device 9 is fixed on the lower surface of the air inlet support 2. The air inlet interface 911 is inserted into the interface 331. The sub-machine support 5 is connected with the outer cover 1 and the lower end of the air inlet support 2.

The upper cover 1 is provided with a knob hole 1A. The operating part 942 is provided with a shaft head 9421; the air inlet support 2 is provided with a circular counter bore 2A, the bottom plate of the circular counter bore 2A is provided with a through hole, and the through hole is opposite to the shaft head 9421.

The system further comprises a driving base 41, a knob 42, a driving gear 43, a driving wheel set 44, a driven wheel set 45, and a drive gear 46.

The driving base 41 comprises a circular base cavity 411, a driving wheel set base 412 and a driven wheel set base 413, wherein the circular base cavity 411 is communicated with the driving wheel set base 412.

The driving wheel set 44 comprises a first gear 441, a second gear 442 and a fixed shaft 443. The driven wheel set 45 comprises a speed reducing wheel 451, a driven wheel 452 and a rotating shaft 453. The driven wheel 452 comprises a shaft body 4521, a cylinder 4522 with an open lower part and teeth provided at the open end of the cylinder.

The driving base 41 is fixed on the air inlet support 2. The lower shaft body of the driving gear 43 is rotatably fitted with the bottom plate of the circular base cavity 411. The connecting rod at the upper end is connected with the connecting part 421 of the knob 42. The body part 422 of the knob 42 is rotatably fitted with the circular base cavity 411. The first gear 441 and the second gear 442 are provided vertically and pivotedly connected to a driving wheel set base 412 by means of a fixed shaft 443. The first gear 441 is engaged with the driving gear 43. A rotating shaft 453 is rotatably fitted with a driven wheel set base 413. The upper end of the rotating shaft is fixedly connected to a speed reducing wheel 451, and the lower end of the rotating shaft is connected to a shaft body 4521 of a driven gear 452.

The drive gear 46 is fixedly connected to a shaft head 9421. The drive gear 46 extends into a circular counter bore 2A through a through hole. The driven gear 452 is located in the circular counter bore 2A and engaged with the drive gear 46. A handheld part 421 of the knob 42 extends out of the upper cover 1 through a knob hole 1A.

The lower end of the shaft base of the first gear 441 of the driving wheel set 44 is provided with a sub-clutch sleeve 4411, the upper end of the shaft base of the second gear 442 is provided with a female clutch sleeve 4421, and the upper end of the fixed shaft 443 is provided with an external thread.

The upper base plate of the driving wheel set base 412 is provided with a threaded hole 4121, and the lower base plate is provided with a fixed hole 4122.

The system further comprises a tension spring 444.

The upper end of the fixed shaft 443 is screwed with the threaded hole 4121 and the lower end thereof is inserted with the fixed hole 4122. The tension spring 444 is sleeved on the fixed shaft 443. The upper end and the lower end of the tension spring 444 are fitted with the shaft base and the lower base plate of the second gear 442, respectively. The sub-clutch sleeve 4411 and the female clutch sleeve 4421 are engaged.

The driving base 41 is provided with a gear cavity 414, and the gear cavity 414 is communicated with the cylindrical base 411 through a guide hole.

The system further comprises a sliding rod 61 and a pressure spring 62, wherein the sliding rod 61 is provided with a spring base plate 611.

The driven end 612 of the sliding rod 61 passes through a pressure spring 62. One end of the pressure spring 62 is opposite to the end plate of the gear cavity 414 and the other end thereof is fitted with the spring base plate 611. The driving end of the sliding rod 61 is fitted with the gear hole on the connecting part 421 of the knob 42 through the guide hole.

The above is only the preferred embodiment of the present utility model. It should be pointed out that several improvements and modifications can be made without departing from the principle of the present utility model for those skilled in the art, which is also regarded as the scope of protection of the present utility model.

What is claimed is:

1. A pressure-adjustable pneumatic system of a soda machine, comprising an upper cover, an air inlet support, an air distribution valve, a sub-machine support, a safety valve, and a piston-type pressure driving device, wherein the air distribution valve comprises an air inlet cavity, an air inlet interface communicated with the air inlet cavity, an exhaust cavity surrounding the air inlet cavity, an exhaust driving pipeline communicated with the exhaust cavity, and an exhaust valve provided on the exhaust driving pipeline, the exhaust driving pipeline is provided with an interface, the piston-type pressure driving device comprises a cylinder with an open end, an air inlet interface provided at the air inlet end of the cylinder, a piston, a sealing rubber plug, an ejector rod connected with the piston, a spring and a push rod nut, wherein the open end of the cylinder is provided with internal threads; the push rod nut comprises a body part, an operating part surrounding the body part, an upper guide hole provided on the body part and a counter hole; the body part comprises an external thread part and a sealing part; the sealing rubber plug is provided at one end of the piston, the sealing rubber plug is fitted with the closed air inlet of the cylinder, the spring is sleeved on the ejector rod, the external thread of the push rod nut is screwed with the internal thread of the cylinder; the spring extends into the counter bore, the ejector rod extends through the guide hole, the piston-type pressure driving device is fixed on the air inlet support, the air inlet interface is inserted into the interface; the sub-machine support is connected with the outer cover and the lower end of the air inlet support; wherein the upper cover is provided with a knob hole; the operating part is provided with a shaft head; the air inlet support is provided with a circular counter bore, the bottom plate of the circular counter bore is provided with a through hole, and the through hole is opposite to the shaft head;
the system further comprises a driving base, a knob, a driving gear, a driving wheel set, a driven wheel set, and a drive gear;
the driving base comprises a circular base cavity, a driving wheel set base and a driven wheel set base, wherein the circular base cavity is communicated with the driving wheel set base; the driving wheel set comprises a first gear, a second gear and a fixed shaft; the driven wheel set comprises a speed reducing wheel, a driven wheel and a rotating shaft, the driven wheel comprises a shaft body, a cylinder with an open lower part and teeth provided at the open end of the cylinder;
the driving base is fixed on the air inlet support, the lower shaft body of the driving gear is rotatably fitted with the bottom plate of the circular base cavity, the connecting rod at the upper end is connected with the connecting part of the knob; the first gear and the second gear are provided vertically and pivotedly connected to a driving wheel set base by means of a fixed shaft, the first gear is engaged with the driving gear; a rotating shaft is rotatably fitted with a driven wheel set base, the upper end of the rotating shaft is fixedly connected to a speed reducing wheel, and the lower end of the rotating shaft is connected to a shaft body of a driven gear;
the drive gear is fixedly connected to a shaft head, the drive gear extends into a circular counter bore through a through hole, and the driven gear is located in the circular counter bore and engaged with the drive gear; and a handheld part of the knob extends out of the upper cover through a knob hole.

2. The pressure-adjustable pneumatic system of a soda machine according to claim 1, wherein the lower end of the shaft base of the first gear of the driving wheel set is provided with a sub-clutch sleeve, the upper end of the shaft base of the second gear is provided with a female clutch sleeve, and the upper end of the fixed shaft is provided with an external thread;
the upper base plate of the driving wheel set base is provided with a threaded hole, and the lower base plate is provided with a fixed hole;
the system further comprises a tension spring,
the upper end of the fixed shaft is screwed with the threaded hole and the lower end thereof is inserted with the fixed hole; the tension spring is sleeved on the fixed shaft; the upper end and the lower end of the tension spring are fitted with the shaft base and the lower base plate of the second gear, respectively; and the sub-clutch sleeve and the female clutch sleeve are engaged.

3. The pressure-adjustable pneumatic system of a soda machine according to claim 1, wherein the driving base is provided with a gear cavity, and the gear cavity is communicated with the cylindrical base through a guide hole;
the system further comprises a sliding rod and a pressure spring, wherein the sliding rod is provided with a spring base plate;
the driven end of the sliding rod passes through a pressure spring, one end of the pressure spring is fitted with the end plate of the gear cavity and the other end thereof is fitted with the spring base plate, and the driving end of the sliding rod is fitted with the gear hole on the connecting part of the knob through the guide hole.
